(19) United States
(12) Patent Application Publication
(10) Pub. No.: US 2006/0159365 A1
(43) Pub. Date: Jul. 20, 2006

(54) Rear projection display device

(75) Inventor: Kun-Rong Chang, Miao Li County (TW)

Correspondence Address: DARBY & DARBY P.C., P. O. BOX 5257, NEW YORK, NY, 10150-5257, US

(73) Assignee: CORETRONIC CORPORATION, Miao Li County (TW)

(21) Appl. No.: 11/298,433

(22) Filed: Dec. 8, 2005

(30) Foreign Application Priority Data
Jan. 20, 2005 (TW) 094101657

(51) Int. Cl. G06K 9/40

(52) U.S. Cl. 382/275

(57) ABSTRACT

A rear projection display device includes a screen, an image-processing unit for receiving an image signal, an optical projection unit forming an image light beam and projecting the light beam to form a projected image on the screen, a photo detection unit for sensing the projected image and outputting a corresponding detection signal, a driver for controlling the optical projection unit to correct the projected image, and a control unit for receiving the detection signal to determine whether there is a distortion of the projected image, and for performing control the image-processing unit or the driver to correct the distortion of the projected image automatically.

### CROSS-REFERENCE TO RELATED APPLICATION

This application claims priority of Taiwanese Application No. 094101657, filed on Jan. 20, 2005.

### BACKGROUND OF THE INVENTION

1. Field of the Invention

The present invention relates to a rear projection display device, more particularly to a rear projection display device that is capable of automatically adjusting a projected image.

2. Description of the Related Art

Referring to FIG. 1, a conventional rear projection display device 9 includes an optical engine 92, a first mirror 93, a second mirror 94, a screen 95, and an adjusting device 800. The optical engine 92, the first mirror 93, the second mirror 94, and the adjusting device 800 are mounted in a housing 91.

The first mirror 93 is mounted in front of the optical engine 92 and is slanted upwardly at an angle. The angle of the first mirror 93 is adjusted by the adjusting device 800. An optical path is formed between the first mirror 93 and the second mirror 94. A light projected from the optical engine 92 can traverse the optical path to be magnified and projected onto the screen 95.

The manufacturing and assembly tolerances of the first and second mirrors 93, 94, as well as an error in an image signal may cause a distortion of the projected image on the screen 95. Furthermore, while moving the rear projection display device 9, the first and second mirrors 93, 94, and the optical engine 92 may undergo vibration or may wobble to cause the positions thereof to be shifted. Such a shift in position also may cause the distortion of the projected image on the screen 95. To correct such the distortion of the projected image, a user can operate a tool through a hole (not shown) on the housing 91 to adjust the position of the optical engine 92, or manipulate the adjusting device 800 to adjust the angle of the first mirror 93. These processes are time-consuming and difficult, particularly since the user must simultaneously perform adjustments and view the projected image.

### SUMMARY OF THE INVENTION

The object of the present invention is to provide a rear projection display device that is capable of automatically adjusting a projected image such that the distortion of the projected image is corrected.

The rear projection display device of the present invention includes a screen, an image-processing unit, an optical projection unit, a photo detection unit, a driver, and a control unit. The image-processing unit receives an image signal and converts the image signal into a format suitable for display on the screen. An optical projection unit includes an optical engine electrically coupled to the image-processing unit to receive the converted image signal from the image-processing unit, the optical engine forming an image light beam using the converted image signal, and a mirror module for projecting the image light beam formed by the optical engine onto the screen to thereby form a projected image on the screen. A photo detection unit senses the projected image formed on the screen, and outputs a corresponding detection signal. A driver is coupled to the optical projection unit, and is operable to make adjustments to at least one of the optical engine and the mirror module of the optical projection unit to thereby adjust the projected image formed on the screen. A control unit is coupled to the image-processing unit, the photo detection unit, and the driver. The control unit receives the detection signal from the photo detection unit to determine presence of distortion of the projected image through a comparison of the detection signal with predetermined image parameters stored in the control unit, after which the control unit controls the driver to operate the optical projection unit to correct the distortion of the projected image automatically.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic view of a conventional rear projection display device;

FIG. 2 is a schematic circuit block diagram of a rear projection display device according to a preferred embodiment of the present invention;

FIG. 3 is a schematic view showing a screen of FIG. 2, a projected image formed on the screen, and photo sensors mounted on the screen;

FIG. 4 is a view similar to FIG. 3, but illustrating an example of a distortion of the projected image caused by the manufacturing and assembly tolerances; and

FIG. 5 is a view similar to FIG. 3, but illustrating an example of a distortion of the projected image caused by an error in an image signal.

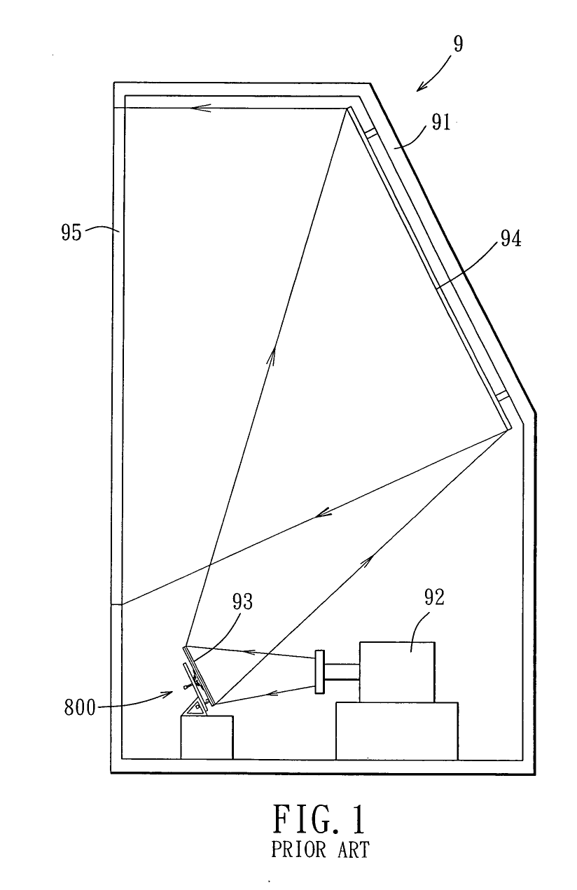

### DETAILED DESCRIPTION OF THE PREFERRED EMBODIMENT

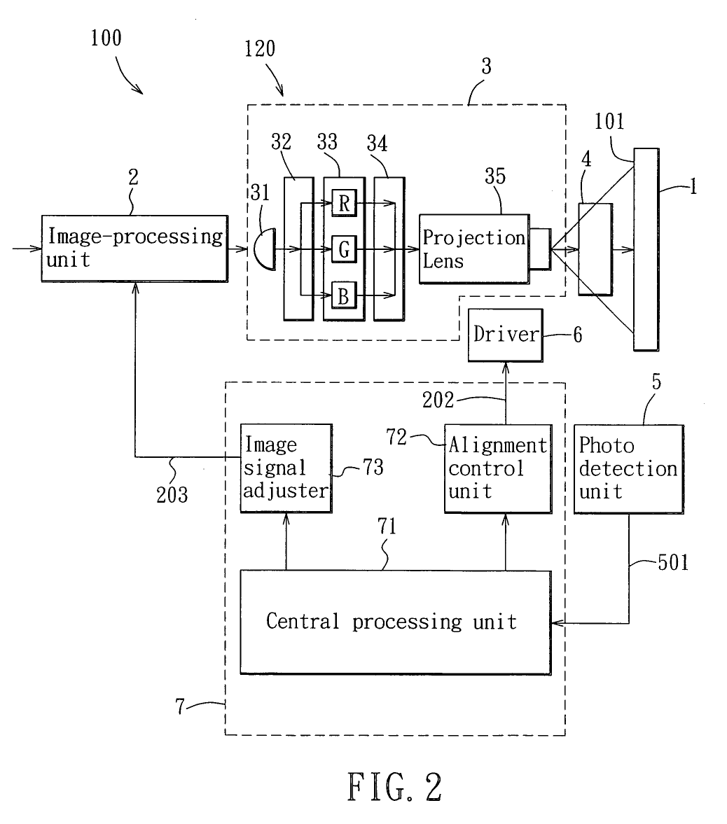

FIG. 2 shows a schematic circuit block diagram of a rear projection display device 100 according to a preferred embodiment of the present invention.

The rear projection display device 100 includes a screen 1, an image-processing unit 2, an optical projection unit 120, a photo detection unit 5, a driver 6, and a control unit 7. The optical projection unit 120 includes an optical engine 3 and a mirror module 4.

The image-processing unit 2 receives an image signal and converts the image signal into a format suitable for obtaining a projected image 101 on the screen 1. The image-processing unit 2 outputs the converted image signal to the optical engine 3.

The optical engine 3 includes an illumination device 31 for generating light beams, a color-separating device 32 for separating the light beams into the three primary colors (i.e., red, green, and blue), a liquid crystal component 33 for receiving the light beams and converting the light beams into modulated light beams according to the image signal from the image-processing unit 2, a light-combining device 34 for combining the modulated light beams, and a projection lens 35 for projecting the combined light beams onto the mirror module 4. The mirror module 4 includes a first mirror (not shown) and a second mirror (not shown), which function to form the projected image 101 on the screen 1 by reflecting the combined light beams from the projection lens 35. Since the structures and operations of, as well as the interaction between, the optical engine 3 and the mirror module 4 are known in the art, a detailed description thereof is omitted herein for the sake of brevity. Only aspects of the optical engine 3 and the mirror module 4 associated with automatic adjustment of a distortion of the projected image 101 according to the present invention are referenced in the following description.

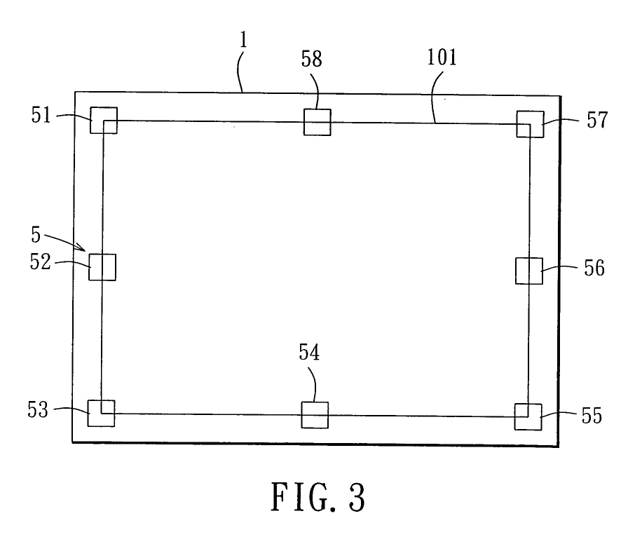

With reference to FIG. 3, the photo detection unit 5 includes a plurality of photo sensors. In the preferred embodiment, there are eight photo sensors 51-58, and each photo sensor 51-58 is a charge coupled device (CCD). The sensors 51-58 are disposed along a periphery of the projected image 101. In particular, the sensors 51, 53, 55, 57 are mounted on the corners of the projected image 101, while the sensors 52, 54, 56, 58 are mounted on middle portions of the periphery of the projected image 101 between the corners of the projected image 101. When the projected image 101 is precisely aligned, the corners of the projected image 101 overlap centers of the sensors 51, 53, 55, 57, and the middle portions of the periphery of the projected image 101 overlap centers of the sensors 52, 54, 56, 58. The sensors 51-58 sense the projected image 101 and transmit a corresponding detection signal 501 to the control unit 7. It is noted that the number and positions of the sensors 51-58 are not limited to those of the preferred embodiment in the present invention.

The driver 6 is coupled to the optical projection unit 120, and is controlled by the control unit 7 to operate the optical engine 3 and/or the mirror module 4 to shift these elements. The control unit 7 is electrically coupled to the image-processing unit 2, the photo detection unit 5, and the driver 6. The control unit 7 includes a central processing unit (CPU) 71, an alignment control unit 72, and an image signal adjuster 73. The CPU 71 contains predetermined image parameters, which are used to determine whether the projected image 101 is accurately formed on the screen 1. The CPU 71 may also determine whether the distortion of the projected image 101, if any, is due to a manufacturing and assembly tolerances or an error in the image signal.

In particular, the CPU 71 determines whether the projected image 101 is distorted through a comparison between the detection signal 501 and the predetermined image parameters. The manner in which the CPU 71 determines whether such the distortion is a result of the manufacturing and assembly tolerances is described in greater detail below. If it is determined that there is the distortion of the projected image 101, and that the distortion is caused by the manufacturing and assembly tolerances, the CPU 71 performs corresponding control of the alignment control unit 72. As a result, the alignment control unit 72 outputs a first control signal 202 to the driver 6. Based on the first control signal 202, the driver 6 adjusts the optical engine 3 and/or the mirror module 4 so that manufacturing and assembly tolerances and shifts caused by vibration are corrected. Such adjustment includes controlling the optical engine 3 and/or the mirror module 4 to move in a forward, rearward, leftward, or rightward direction, to rotate, or to undergo some combination of movements. Hence, the projected image 101 may be reduced, enlarged, leftwardly moved, rightwardly moved, and/or tilted such that the projected image 101 is accurately displayed on the screen 1.

On the other hand, if it is determined that the distortion of the projected image 101 is due to an error in the image signal, the CPU 71 performs corresponding control of the image signal adjuster 73. As a result, the image signal adjuster 73 outputs a second control signal 203 to the image-processing unit 2 such that the image signal converted by the image-processing unit 2 is appropriately adjusted. As an example, the image signal adjuster 73 may include a scalar chip that outputs a scaling signal to the image-processing unit 2 to scale the image signal converted by the image-processing unit 2.

Hence, correction may be performed of the distortion of the projected image 101 caused by manufacturing and assembly tolerances, shifts resulting from vibration, and an error in the image signal.

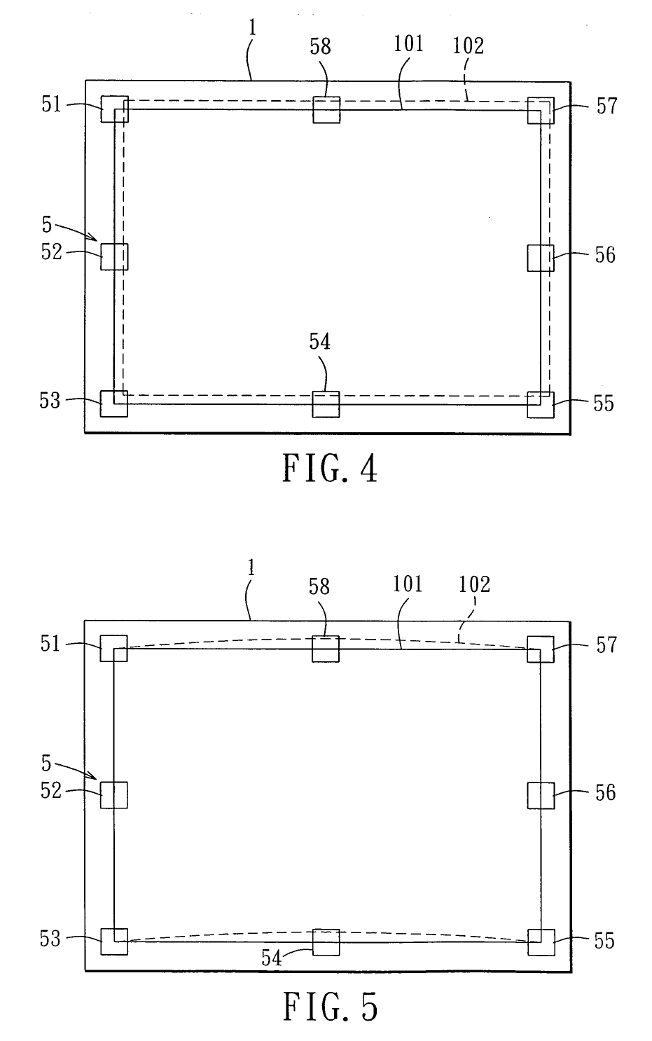

Referring to FIG. 4, the distortion of the projected image 101 caused by manufacturing and assembly tolerances and shifts is shown by dotted lines 102. The solid line that draws the projected image 101 is where the projected image 101 should be positioned. In the preferred embodiment, the CPU 71 determines from the detection signal 501 output by the sensors 51-58 whether the centers of sensors 51-58 overlap the periphery of the projected image 101. The CPU 71 is able to determine whether there is the distortion of the projected image 101 through a comparison between the detection signal 501 output by the sensors 51-58 and the image parameters stored therein. Furthermore, the CPU 71 is able to determine from the detection signal 501 whether the distortion of the projected image 101 is caused by manufacturing and assembly tolerances and shifts resulting from vibration since the projected image 101 is shifted by equal amounts at all the sensors 51-58. In this case, the CPU 71 then performs control of the alignment control unit 72 such that the alignment control unit 72 outputs the first control signal 202 to the driver 6 to thereby effect adjustment of the optical engine 3 and/or the mirror module 4 so that manufacturing and assembly tolerances and shifts caused by vibration are corrected.

With Referring to FIG. 5, the dotted lines 102 show the distortion of the projected image 101 caused by an error in the image signal. The CPU 71 determines from the received detection signal 501 that the periphery of the projected image 101 is misaligned at each center of the sensors 54, 58, while the corners of the projected image 101 are aligned at each center of the sensors 51-53, 55-57. It is, therefore, determined by the CPU 71 that the distortion of the projected image 101 is due to an error in the image signal. Hence, the CPU 71 performs corresponding control of the image signal adjuster 73. As a result, the image signal adjuster 73 outputs the second control signal 203 to the image-processing unit 2 such that the image signal converted by the image-processing unit 2 is appropriately adjusted.

Determination that the distortion of the projected image 101 is due to inaccuracies in the image signal may take many forms in addition to the example described above. However, common to all situations of image signal inaccuracies is a determination by the CPU 71 that detection values of certain oppositely disposed sensors are increased and decreased by equal amounts, while equal at the remaining sensors.

In the rear projection display device 100 of the present invention as described above, the distortion of the projected image 101 caused by manufacturing and assembly tolerances, shifts resulting from vibration, and an error in the image signal can be automatically detected and corrected, thereby providing convenience to the user.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A rear projection display device, comprising:
a screen;
an image-processing unit for receiving an image signal to convert said image signal into a format suitable for display on said screen;
an optical projection unit comprising an optical engine and a mirror module, said optical engine being electrically coupled to said image-processing unit, said optical engine receiving said converted image signal from said image-processing unit to form an image light beam, said mirror module projecting said image light beam to form a projected image on said screen;
a photo detection unit for sensing said periphery of said projected image and outputting a corresponding detection signal;
a driver coupled to said optical projection unit for operating at least one of said optical engine and said mirror module to adjust said projected image; and
a control unit electrically coupled to said image-processing unit, said photo detection unit, and said driver, said control unit receiving said detection signal to determine whether there is a distortion of said projected image through a comparison between said detection signal and predetermined image parameters stored in said control unit, and said control unit controlling said driver to operate said optical projection unit to correct said distortion of said projected image automatically.

2. The rear projection display device of claim 1, wherein said control unit comprises a central processing unit for determining whether there is said distortion of said projected image, and an alignment control unit for controlling said driver to operate said optical projection unit to correct said distortion of said projected image automatically.

3. The rear projection display device of claim 2, wherein said control unit further comprises an image signal adjuster coupled to said central processing unit and said image-processing unit, said image signal adjuster controlling said image-processing unit to scale said image signal.

4. The rear projection display device of claim 1, wherein said photo detection unit includes a plurality of photo sensors mounted on said screen at locations overlapping a periphery of said projected image.

5. The rear projection display device of claim 4, wherein centers of said sensors are disposed on corners of said projected image.

6. The rear projection display device of claim 4, wherein centers of said sensors are disposed on middle portions of said periphery of said projected image between corners of the projected image.
